(19) United States
(12) Patent Application Publication
(10) Pub. No.: US 2026/0042570 A1
(43) Pub. Date: Feb. 12, 2026

(54) CONTAINER WITH DIVIDER

(71) Applicant: Graphic Packaging International, LLC, Atlanta, GA (US)

(72) Inventors: Lee Nowak, Leicestershire (GB); Liam Cooke, Leicestershire (GB)

(21) Appl. No.: 19/291,068

(22) Filed: Aug. 5, 2025

Related U.S. Application Data
(60) Provisional application No. 63/679,809, filed on Aug. 6, 2024.
(60) Provisional application No. 63/759,338, filed on Feb. 17, 2025.

(51) Int. Cl. B65D 5/48; B31B 50/26; B31B 105/00; B31B 120/40; B65D 5/20; B65D 5/28; B65D 5/56

(52) U.S. Cl. CPC B65D 5/48002; B31B 50/262; B65D 5/2033; B65D 5/28; B65D 5/566; B31B 2105/00; B31B 2120/40

(57) ABSTRACT

A container for holding one or more articles includes an upper crown, the upper crown having a flange panel extending at least partially around an opening and a plurality of flaps foldably connected to the flange panel, the flange panel at least partially forming a flange of the container, a base construct, the base construct including a bottom panel and a plurality of panels foldably connected to the bottom panel, the plurality of flaps of the upper crown and the plurality of bottom panels of the base construct forming a sidewall extending at least partially around an interior of the container, and divider structures including a plurality of divider panels foldably connected to a respective panel of the plurality of panels of the base construct and forming the divider structures, the divider structures at least partially forming respective portions of the sidewall extending into the interior of the container.

### CROSS-REFERENCE TO RELATED APPLICATIONS

The present application claims the benefit of U.S Provisional patent application No. U.S. Provisional Patent Application No. 63/759,338, filed on Feb. 17, 2025, and U.S. Provisional Patent Application No. 63/679,809, filed Aug. 6, 2024.

### INCORPORATION BY REFERENCE

The disclosures of U.S. Provisional Patent Application No. 63/759,338, filed on Feb. 17, 2025, U.S. Provisional Patent Application No. 63/679,809, filed Aug. 6, 2024, U.S. Provisional Patent Application No. 63/543,560, filed Oct. 11, 2023, U.S. Provisional Patent Application No. 63/541,446, filed Sep. 29, 2023, U.S. Provisional Patent Application No. 63/533,393, filed Aug. 18, 2023, U.S. patent application Ser. No. 16/037,425, filed Jul. 17, 2018, U.S. patent application Ser. No. 15/654,814, filed Jul. 20, 2017, and U.S. patent application Ser. No. 12/992,131, filed Feb. 11, 2011, are hereby incorporated by reference for all purposes as if presented herein in their entirety.

### BACKGROUND OF THE DISCLOSURE

The present disclosure relates to blanks, containers, trays, constructs, and various features and methods for forming a container from a blank. More specifically, the disclosure is generally directed to a container having a liner.

### SUMMARY OF THE DISCLOSURE

According to one aspect, the disclosure is generally directed to a container for holding one or more articles, the container comprising an upper crown, the upper crown comprising a flange panel extending at least partially around an opening and a plurality of flaps foldably connected to the flange panel, the flange panel at least partially forming a flange of the container, a base construct, the base construct comprising a bottom panel and a plurality of panels foldably connected to the bottom panel, the plurality of flaps of the upper crown and the plurality of bottom panels of the base construct forming a sidewall extending at least partially around an interior of the container, and divider structures comprising a plurality of divider panels foldably connected to a respective panel of the plurality of panels of the base construct and forming the divider structures, the divider structures at least partially forming respective portions of the sidewall extending into the interior of the container.

According to another aspect, the disclosure is generally directed to a combination of blanks for a container for holding one or more articles, the container comprising a crown blank for forming an upper crown, the crown blank comprising a flange panel extending at least partially around an opening and a plurality of flaps foldably connected to the flange panel, the flange panel for at least partially forming a flange of the container, a base blank for forming a base construct, the base blank comprising a bottom panel and a plurality of panels foldably connected to the bottom panel, the plurality of flaps of the crown blank and the plurality of panels of the base blank for forming a sidewall extending at least partially around an interior of the container formed from the combination of blanks, and a plurality of divider panels foldably connected to a respective panel of the plurality of panels of the base construct for forming divider structures, the divider structures at least partially forming respective portions of the sidewall extending into the interior of the container formed from the combination of blanks.

According to another aspect, the disclosure is generally directed to a method of forming a container for holding one or more articles, the method comprising obtaining a crown blank, the crown blank comprising a flange panel extending at least partially around an opening and a plurality of flaps foldably connected to the flange panel, obtaining a base blank, the base blank comprising a bottom panel and a plurality of panels foldably connected to the bottom panel, the base blank further comprising a plurality of divider panels foldably connected to a respective panel of the plurality of panels of the base construct, forming an upper crown from the crown blank, forming a base construct from the base blank, at least partially forming a flange from the flange panel, forming a sidewall from the plurality of flaps of the crown blank and the plurality of panels of the base blank such that the sidewall extends at least partially around an interior of the container, and forming divider structures from the plurality of divider panels such that the divider structures at least partially form respective portions of the sidewall extending into the interior of the container.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a bottom blank used for forming a bottom component of a container according to a first exemplary embodiment of the disclosure.

FIG. 2 is a plan view of a top blank used for forming a crown component of the container according to the first exemplary embodiments of the disclosure.

FIG. 3 is a top perspective view of a container formed from the blanks of FIGS. 1 and 2 according to the first exemplary embodiment of the disclosure.

FIG. 4 is a bottom perspective view of a container formed from the blanks of FIGS. 1 and 2 according to the second exemplary embodiment of the disclosure.

FIG. 5 is a plan view of a bottom blank used for forming a bottom component of a container according to a second exemplary embodiment of the disclosure.

FIG. 6 is a plan view of a top blank used for forming a crown component of the container according to the second exemplary embodiments of the disclosure.

FIG. 7 is a top perspective view of a container formed from the blanks of FIGS. 5 and 6 according to the second exemplary embodiment of the disclosure.

FIG. 8 is a bottom perspective view of a container formed from the blanks of FIGS. 5 and 6 according to the second exemplary embodiment of the disclosure.

FIG. 9 is a plan view of a bottom blank used for forming a bottom component of a container according to a third exemplary embodiment of the disclosure.

FIG. 10 is a plan view of a top blank used for forming a crown component of the container according to the third exemplary embodiments of the disclosure.

FIG. 11 is a top perspective view of a container formed from the blanks of FIGS. 9 and 10 according to the third exemplary embodiment of the disclosure.

FIG. 12 is a bottom perspective view of a container formed from the blanks of FIGS. 9 and 10 according to the third exemplary embodiment of the disclosure.

FIG. 13 is a plan view of a bottom blank used for forming a bottom component of a container according to a fourth exemplary embodiment of the disclosure.

FIG. 14 is a plan view of a top blank used for forming a crown component of the container according to the fourth exemplary embodiments of the disclosure.

FIG. 15 is a top perspective view of a container formed from the blanks of FIGS. 13 and 14 according to the fourth exemplary embodiment of the disclosure.

FIG. 16 is a bottom perspective view of a container formed from the blanks of FIGS. 13 and 14 according to the fourth exemplary embodiment of the disclosure.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In illustrated embodiments, the present disclosure relates to forming a container or tray for holding food items or various other articles. However, in other embodiments, the container or tray can be used to form other non-food containing articles or may be used for heating or cooking. In this specification, the terms “inner,” “interior,” “outer,” “exterior,” “lower,” “bottom,” “upper,” and “top” indicate orientations determined in relation to fully erected and upright packages. As described herein, constructs can be formed from blanks and/or other constructs with multiple panels, portions, tabs, flaps, sections, lines of weakening, openings, apertures, and/or other aspects, which may be designated herein in terms relative to one another, e.g., “first”, “second”, “third”, etc., in sequential or nonsequential reference, without departing from the disclosure.

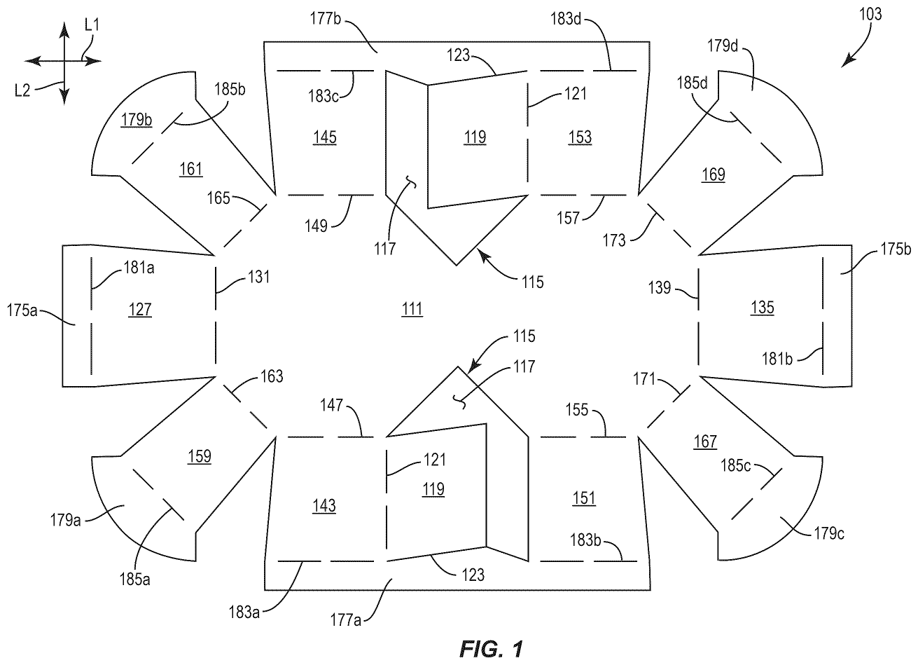

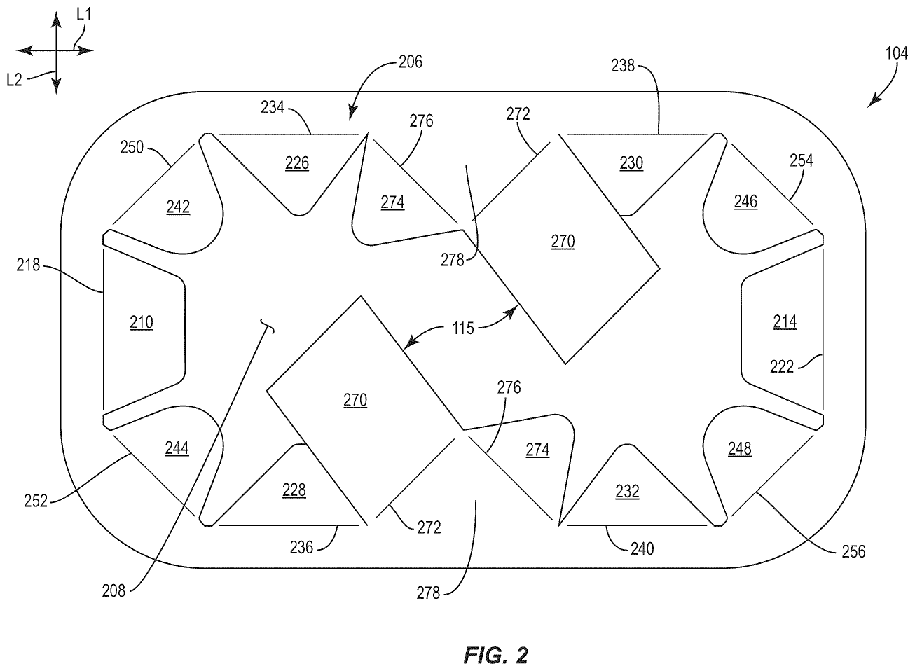

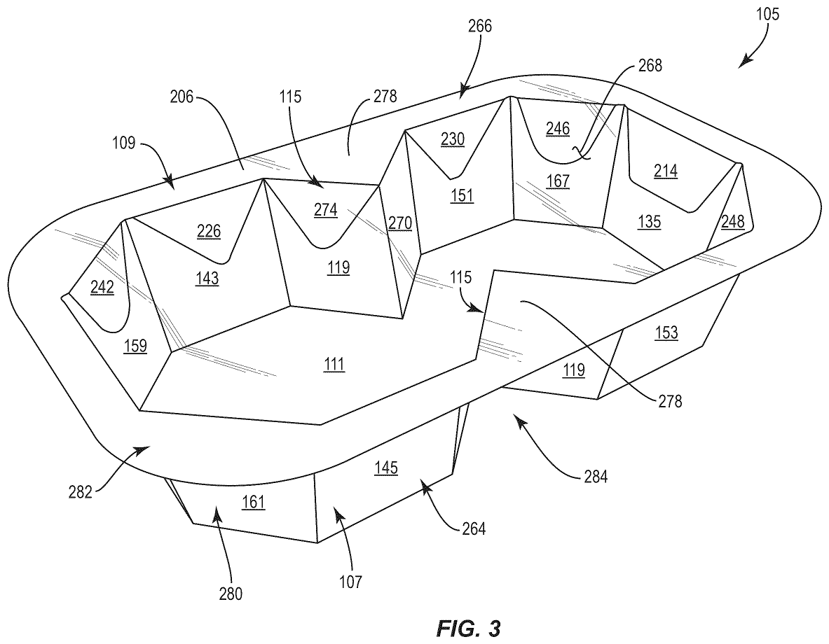

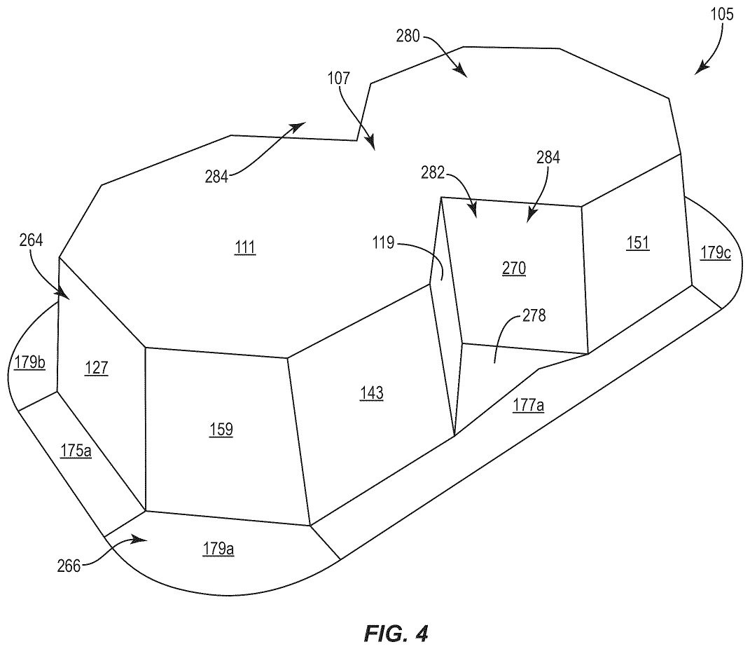

FIGS. 1 and 2 illustrate a first, bottom, or base blank 103 and a second, top, or crown blank 104, respectively, that are used to form a container 105 (FIGS. 3 and 4) having a base layer 107 and a liner 109 according to a first exemplary embodiment of the disclosure. In exemplary embodiments, the blanks 103, 104 and the base layer 107 comprise paperboard (e.g., solid bleached sulphate folding boxboard), or other suitable material that can be recyclable, and the liner 109 comprises a plastic layer such as polyethylene, PET material, or any other thermoplastic material, or a bioplastic, such as vegetable oil or starch-based plastics. The container 105 can be suitable for holding and/or displaying one or more articles (e.g., food products) for sale, transportation, storage, cooling, freezing, etc. and/or for heating a food product in an oven such as a convection or conventional heating oven or microwave oven. In the illustrated embodiment, the liner 109 can be adhered and/or otherwise secured to the base layer 107 and can be in contact with the food product held in the container 105. After heating the food product, the base layer 107 and the liner 109 can be separated to allow both the base layer 107 and the liner 109 to be placed in separate waste streams (e.g., for recycling, composting, incineration, landfill, etc.). In embodiments, the container 105 can include divider structures 115 formed from aspects of the base blank 103 and the crown blank 104.

As shown in FIG. 1, the bottom blank 103 has a longitudinal direction L1 and a lateral direction L2. In the illustrated embodiment, the bottom blank 103 has a bottom panel 111, a first end panel 127 foldably connected to the bottom panel 111 along a lateral fold line 131, and an opposing second end panel 135 foldably connected to the bottom panel 111 along a lateral fold line 139. As shown in FIG. 1, a first side panel 143 and an opposing second side panel 145 can be foldably connected to the bottom panel 111 along respective longitudinal fold lines 147, 149, and a third side panel 151 and an opposing fourth side panel 153 can be foldably connected to the bottom panel 111 along respective longitudinal fold lines 155, 157.

In the illustrated embodiment, the bottom blank 103 can include corner panels 159, 161 respectively foldably connected to the bottom panel 111 along respective oblique fold lines 163, 165 and corner panels 167, 169 respectively foldably connected to the bottom panel 111 along respective oblique fold lines 171, 173. As shown in FIG. 1, the corner panel 159 is disposed between the first end panel 127 and the first side panel 143, the corner panel 161 is disposed between the first end panel 127 and the second side panel 145, the corner panel 167 is disposed between the second end panel 135 and the third side panel 151, and the corner panel 169 is disposed between the second end panel 135 and the fourth side panel 153. In the illustrated embodiment, each of the end panels 127, 135 can be foldably connected to a respective flange portion 175a, 175b along respective lateral fold lines 181a, 181b, each of the side panels 143, 151 can be foldably connected to a flange portion 177a along respective longitudinal fold lines 183a, 183b, each of the side panels 145, 153 can be foldably connected to a flange portion 177b along respective longitudinal fold lines 183c, 183d, and each of the corner panels 159, 161, 167, 169 can be foldably connected to a respective flange portion 179a, 179b, 179c, 179d along respective oblique fold lines 185a, 185b, 185c, 185d (e.g., the flange portions can be portions of the respective end panels, side panels. and corner panels at least partially defined by the respective fold lines).

In embodiments, the end panels 127, 135, the side panels 143, 145, 151, 153, and/or the corner panels 159, 161, 167, 169 could be referred to as panels of a plurality of panels (e.g., sidewall panels of a plurality of sidewall panels). For example, any of the panels 127, 135, 143, 145, 151, 153, 159, 161, 167, 169 could be referred to as a first sidewall panel, a second sidewall panel, a third sidewall panel, etc.

As shown in FIG. 1, the portions of the divider structures 115 in the bottom blank 103 can include cutouts 117 extending along the respective side panels 145, 151, the respective flange portions 177a, 177b, and the bottom panel 111. Further, the divider structures 115 can include base divider panels 119 foldably connected to the respective side panels 151, 145 along respective lateral fold lines 121 and extending along the respective cutouts 117. In exemplary embodiments, the base divider panels 119 can be separable from the respective flange portions 177a, 177b along respective cut lines 123 or other suitable lines of weakening. As shown in FIG. 1, each of the cutouts 117 can extend along oblique edges of the bottom panel 111 so that the portions of the cutouts 117 in the bottom panel 111 are triangular (e.g., generally triangular). Further, each of the cutouts 117 can extend between lateral edges of the respective base divider panel 119 and the respective side panel 151, 153. The cutouts 117 and/or the base divider panels 119 could have any suitable shape and/or position without departing from the disclosure.

The base blank 103 can be otherwise shaped, arranged, and/or configured without departing from the disclosure. In addition, any of the bottom panel 111, the end panels 127, 135, the side panels 143, 145, 151, 153, the corner panels 159, 161, 167, 169, the flange portions 175a, 175b, 177a, 177b, 179a, 179b, 179c, 179d, the cutouts 117, and/or the base divider panels 119 could be omitted or could be otherwise shaped, arranged, positioned, and/or configured without departing from the disclosure. For example, the bottom blank 103 could have any suitable number of panels and any suitable shape for the perimeter around the bottom panel 111.

As shown in FIG. 2, the crown blank 104 has a longitudinal direction L1 and a lateral direction L2 and includes a flange panel 206 extending around a perimeter of the top blank 104 (e.g., continuously around the top blank 104 for forming a smooth, continuous upper surface of the flange of the container 105 for attaching the liner 109 and/or a lid film). In the illustrated embodiments, the top blank 104 can include a central opening 208 (e.g., at least partially defined by an inner edge of the flange panel 206. A first end flap 210 and a second end flap 214 can be foldably connected to the flange panel 206 along the central opening 208 along respective lateral fold lines 218, 222. As shown in FIG. 2, the blank 104 can include a first side flap 226, a second side flap 228, a third side flap 230, and a fourth side flap 232 foldably connected to the flange panel 206 along respective longitudinal fold lines 234, 236, 238, 240. In the illustrated embodiments, corner flaps 242, 244, 246, 248 can be foldably connected to the flange panel 206 along respective oblique fold lines 250, 252, 254, 256.

As shown in FIG. 2, portions of the divider structures 115 in the top blank 104 can include top divider panels 270 foldably connected to the flange panel 206 along respective oblique fold lines 272 and top divider flaps 274 foldably connected to the flange panel 206 along respective oblique fold lines 276. In the illustrated embodiments, each pair of the oblique fold lines 272, 276 can extend from a respective vertex, at least partially forming a triangular and/or wedge-shaped extension 278 of the flange panel 206 into the central opening 208. In embodiments, the top divider panels 270 can be on opposite sides of the wedge-shaped extensions 278 from one another, and the top divider flaps 274 can be on opposite sides of the wedge-shaped extensions 278 from one another.

The crown blank 104 can be otherwise shaped, arranged, and/or configured without departing from the disclosure. In addition, any of the flange panel 206, the end flaps 210, 214, the side flaps 226, 228, 230, 232, the corner flaps 242, 244, 246, 248, the top divider panels 270, the divider flaps 274, and/or the wedge-shaped extensions 278 could be omitted or could be otherwise shaped, arranged, positioned, and/or configured without departing from the disclosure. For example, the crown blank 104 could have any suitable number of panels and any suitable shape for the perimeter around the central opening 208.

When the container 105 is formed from the bottom blank 103 and the top blank 104 (e.g., manually or by a forming tool), the panels 127, 135, 143, 145, 151, 153, 159, 161, 167, 169 can be folded upwardly relative to the bottom panel 111 along their respective fold lines, and the flange portions 175a, 175b, 177a, 177b, 179a, 179b, 179c, 179d can be folded outwardly relative to the respective panels 127, 135, 143, 145, 151, 153, 159, 161, 167, 169.

Referring additionally to FIGS. 3 and 4, the bottom blank 103 can be formed into a base 280 by upwardly folding the end panels 127, 135, the side panels 143, 145, 151, 153, and the corner panels 159, 161, 167, 169 and outwardly folding the flange portions 175a, 175b, 177a, 177b, 179a, 179b, 179c, 179d (e.g., so that the corner panel 159 abuts and/or is proximate to the first end panel 127 and the first side panel 143, the corner panel 161 abuts and/or is proximate to the first end panel 127 and the second side panel 145, the corner panel 167 abuts and/or is proximate to the second end panel 135 and the third side panel 151, and the corner panel 169 abuts and/or is proximate to the second end panel 135 and the fourth side panel 153 and/or so that the flange portions are in abutting relationship with and/or proximate to the respectively adjacent flange portions), In embodiments, each of the base divider panels 119 can be positioned along a respectively adjacent oblique edge of the base panel 111 extending along the cutout 117 so that the base divider panels 119 extend obliquely with respect to the side panels 143, 145, 151, 153. The base 280 could be otherwise formed without departing from the disclosure.

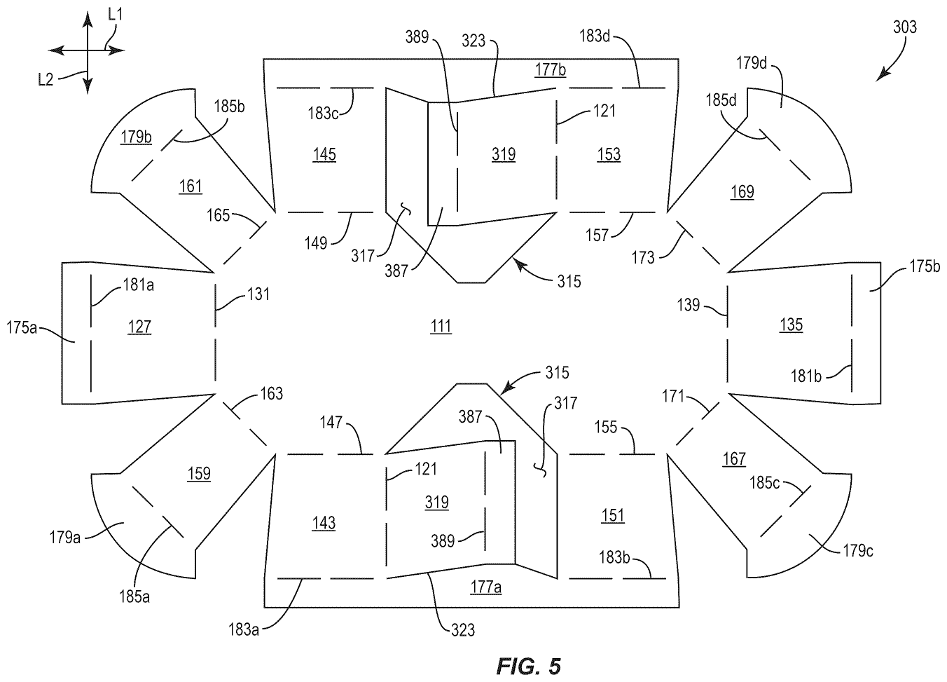

In the illustrated embodiments, the container 105 further can be formed by placing the flange panel 206 of the top blank 104 over the outwardly-folded flange portions 175a, 175b, 177a, 177b, 179a, 179b, 179c, 179d of the base 280 so that the flange portions and the flange panel are in face-to-face contact (e.g., the flange portions are in face-to-face contact with the bottom surface of the flange panel). The flaps 210, 214, 226, 228, 230, 232, 242, 244, 246, 248 of the top panel 104 can be downwardly folded along their respective fold lines so that the flaps 210, 214, 226, 228, 230, 232, 242, 244, 246, 248 overlap the respective panels 127, 135, 143, 145, 151, 153, 159, 161, 167, 169 (FIGS. 4 and 5). Further, the top divider panels 270 and the top divider flaps 274 can be downwardly folded relative to the flange panel 206. In embodiments, a crown 282 can be formed from the top blank 104. As shown in FIGS. 3 and 4, the flaps 210, 214, 226, 228, 230, 232, 242, 244, 246, 248 and the panels 127, 135, 143, 145, 151, 153, 159, 161, 167, 169 can cooperate to form a sidewall 264 extending along an interior 268 of the container 105. Similarly, the flange portions 175a, 175b, 177a, 177b, 179a, 179b, 179c, 179d and the flange panel 206 can cooperate to form a flange 266 of the container 105, with the flange panel 206 providing a smooth, continuous upper surface of the flange 266.

As shown in FIGS. 3 and 4, the divider structures 115 can be formed by folding the base divider panels 119 along the lateral fold lines 121 so that the base divider panels extend along a respective oblique edge of the bottom panel 111 along the respective cutouts 117 and folding the top divider panels 270 downwardly along the oblique fold lines 272 so that edges of the top divider panels 270 extend along and/or adjacent (e.g., abut) respective edges of the respective side panels 143, 153, the respective bottom divider panels 119, and the bottom panel 111 along the respective cutouts 117. In embodiments, the divider structures 115 can form portions of the sidewall 264 extending into the interior 268 of the container 105 and can help retain one or more products in respective compartments of the container 105 (e.g., on opposite sides of the divider 262). The divider structures 115 could be otherwise formed without departing from the disclosure.

In embodiments, a liner material 109 can be applied over at least the sidewall 264, the flange 266, the bottom panel 111, and the divider structures 115 so that the liner material can form a liner 109 adhered to at least the overlapped flaps and panels of the sidewall 264, to the bottom panel 111, and to the divider panels 119, 272 and the divider flaps 274 of the divider structures 115 along the interior 268 of the container 105. In embodiments, the liner 109 can be attached along at least a portion of the flange panel 206. In exemplary embodiments, the liner 109 can be adhered to the base layer 107 by a heat seal layer, adhesive, and/or other suitable features. In the illustrated embodiments, the attachment of the liner 109 to the base layer 107 can attach the flaps 210, 214, 226, 228, 230, 232, 242, 244, 246, 248, 274 to the respective panels 127, 135, 143, 145, 151, 153, 159, 161, 167, 169, 119.

As shown in FIGS. 3 and 4, the flaps 210, 214, 226, 228, 230, 232, 242, 244, 246, 248, 274 are smaller than the respective panels 127, 135, 143, 145, 151, 153, 159, 161, 167, 169, 119 so that portions of each of the flaps and panels are in contact with the liner 109. In embodiments, the liner 109 can at least partially hold the portions of the base layer 107 together and maintain the shape of the container 105. Alternatively, or in addition, one or more aspects of the base layer 107 can be attached by thermo-mechanical sealing, adhesive, etc.

The sidewall 264 and the bottom panel 111 extend around and at least partially define the interior 268 of the container 105, and the divider structures 115 extend inwardly into the interior 268 from the sidewall 264 to at least partially form two interior portions of the container 105 for at least partially separating products held in the container 105. In exemplary embodiments, each of the divider structures 115 can have a triangular (e.g., generally triangular) cross-section, with the vertices of the divider structures 115 pointing toward one another in the interior 268 of the container 105. In this regard, the divider structures 115 can have an at least partially wedge-shaped configuration. In the illustrated embodiments, the divider structures 115 can facilitate stacking of the containers 105. For example, the divider structures 115 can at least partially define openings or recesses 284 in the bottom panel 111 and the sidewall 264 that can at least partially receive the divider structures 115 of a lower container 105 when the containers are stacked.

In embodiments, the angles of the divider structures 115 can help increase the rigidity of the container 105, and the divider structures 115 do not form openings and/or other absences of board/the base layer 207 when the carton 105 is formed. In embodiments, the divider structures 115 form a full height separation feature formed from the sidewall 264 (e.g., from the double wall thickness of the side panels). In embodiments, since the divider structures 115 are formed from the sidewall 264 instead of the bottom wall of the container 105 and are formed from aspects of the base blank 103 and the crown blank 104, the footprint of the blanks 103, 104 and the carton is not increased when compared to blanks/containers without the divider features. This can allow for a greater range of proportions/sizes of blanks and/or containers when compared to other divider embodiments (e.g., divider features that increase the footprint of the blanks).

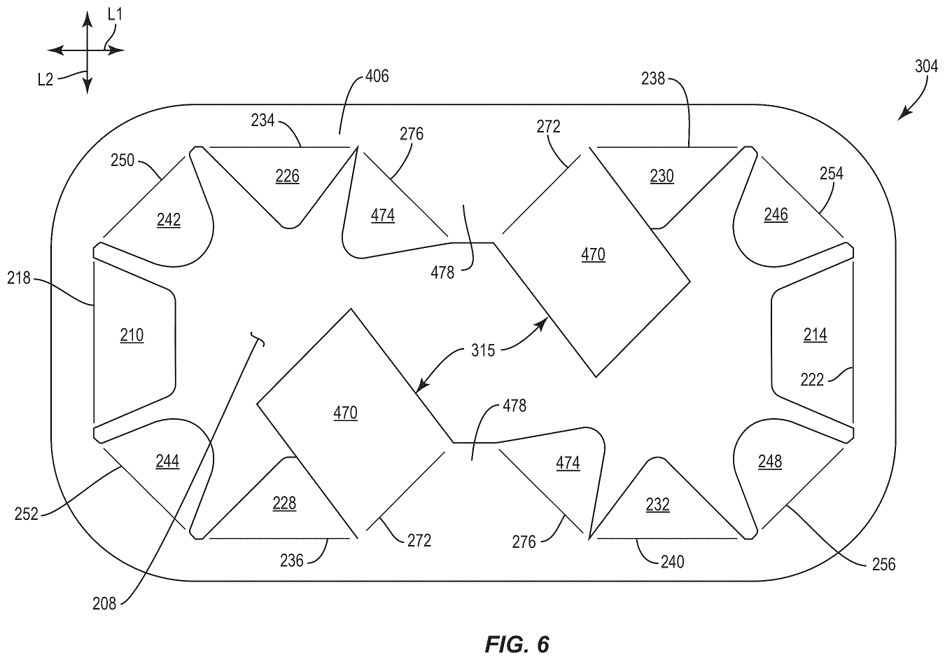

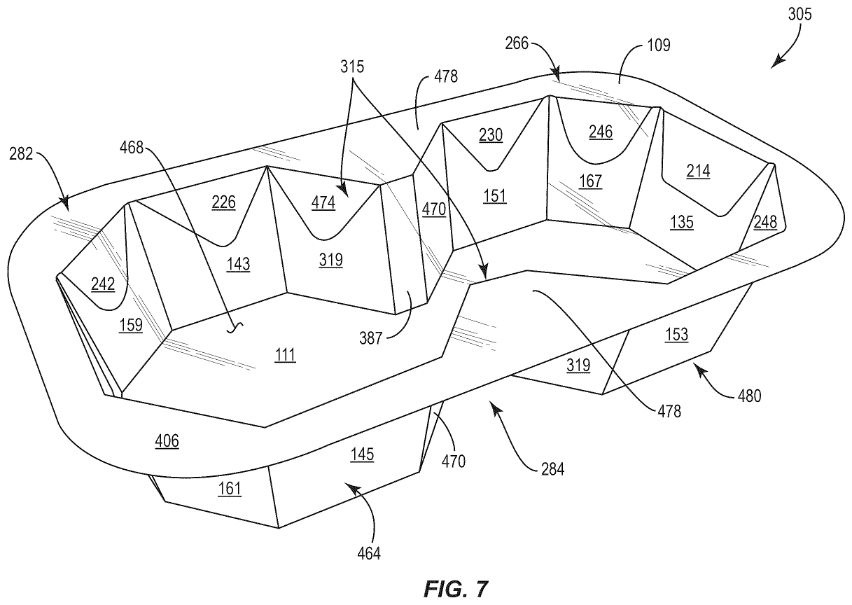

FIGS. 5 and 6 are plan views of a respective first, bottom, or base blank 303 and second or top or crown blank 304 for forming a container 305 (FIG. 7) of a second exemplary embodiment of the disclosure (e.g., a container including a crown or crown component 482 formed from the top blank 304 and a bottom construct or component 480 formed from the bottom blank 303, wherein the crown 482 and the bottom construct 480 can be secured together by at least a liner 109 to form a base layer). The second exemplary embodiment is generally similar to the first exemplary embodiment, except for variations noted and variations that will be apparent to one of ordinary skill in the art. Accordingly, similar or identical features of the embodiments have been given like or similar reference numbers. For example, the divider structures 315 of the container 305 can have a different shape.

As shown in FIG. 5, the base blank 303 can include bottom divider panels 319 foldably connected to the respective side panels 143, 153 along respective lateral fold lines 121 and a bottom divider flap 387 foldably connected to each of the bottom divider panels 319 along respective lateral fold lines 389. In embodiments, the bottom divider panel 319 and the bottom divider flap 387 can be separable from the respective flange portions 177a, 177b along respective cut lines 323 or other suitable lines of weakening. In the illustrated embodiments, each of the bottom divider flaps 387 can extend along a cutout 317, which can be similar to the cutouts 117 shown in FIG. 1, except that the oblique edges of the bottom panel 111 can extend from respective ends of respective longitudinal edges of the bottom panel 111.

As shown in FIG. 6, the top blank 304 is similar to the top blank 104 of FIG. 2, except that each of the top divider flaps 474 is spaced apart from the respective top divider panels 470 by respective longitudinal edges of the extensions 478 of the flange panel 406 extending along the central opening 408. The blanks 303, 304 could be otherwise shaped, arranged, positioned, and/or configured without departing from the disclosure.

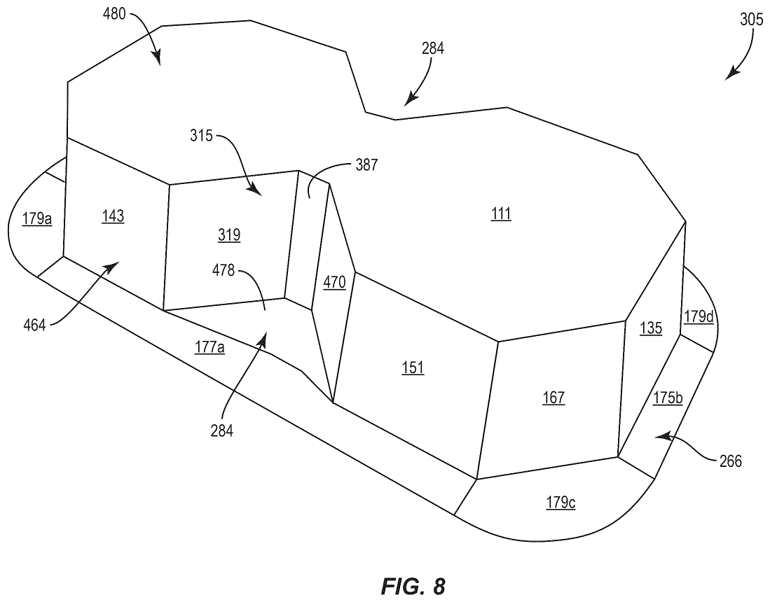

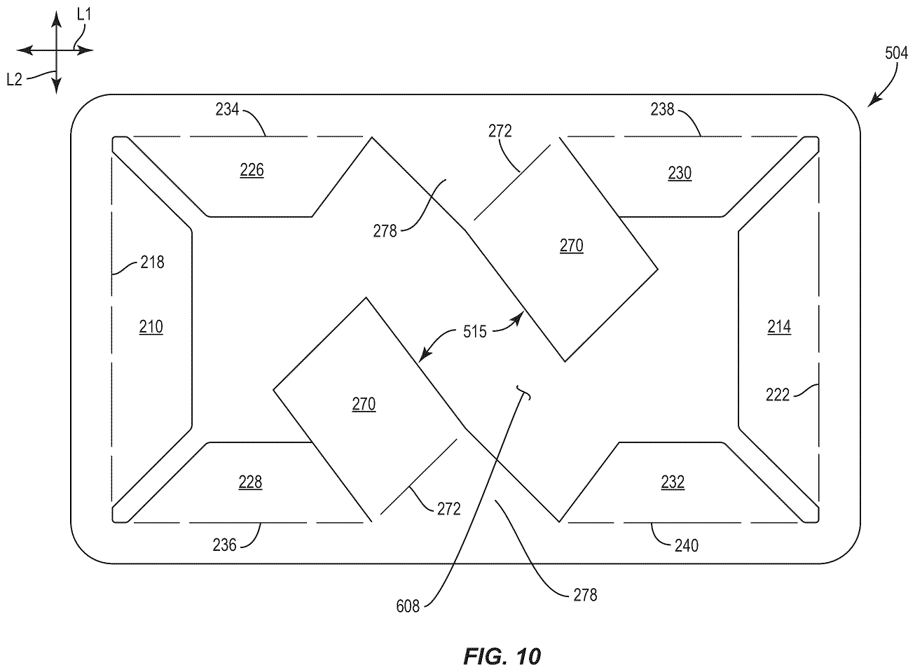

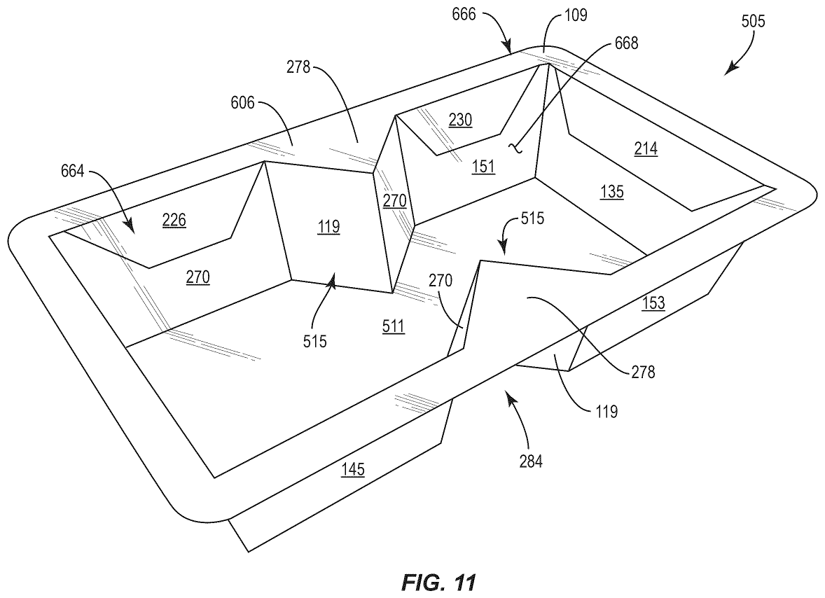

In the illustrated embodiments, the container 305 (FIGS. 7 and 8) can be formed in a similar manner as the container 105 (FIGS. 3 and 4), wherein the container 305 has a base construct 480 and a crown 482. As shown in FIGS. 10 and 11, the sidewall 464 and the bottom panel 111 extend along the interior 468 of the container 305, and the divider structures 315 extend inwardly into the interior 468 from the sidewall 464 to at least partially form two interior portions of the container 305. In the illustrated embodiments, each of the divider structures 315 can have three sides extending along the interior 468 of the container 305, with the bottom divider flaps 387 facing one another in the interior 486. In this regard, the divider structures 315 can be at least partially wedge-shaped.

The blanks 303, 304 and/or the container 305 could be otherwise shaped, arranged, positioned, and/or configured without departing from the disclosure.

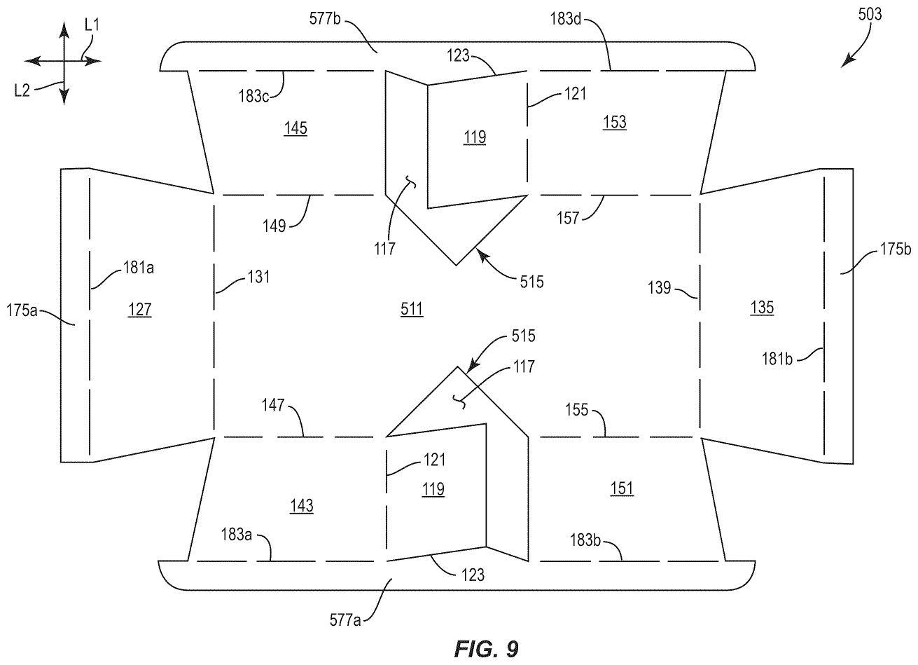

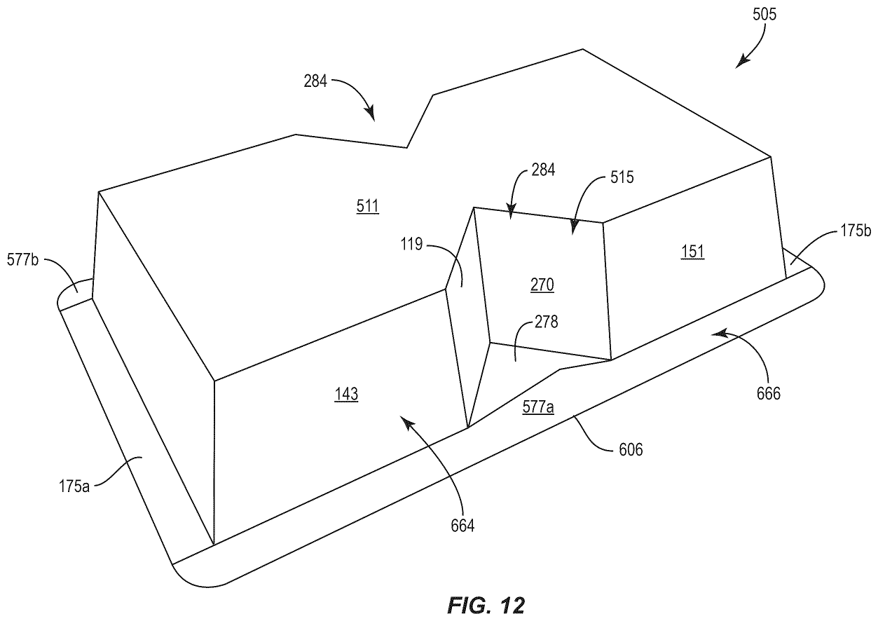

FIGS. 9 and 10 are plan views of a respective first, bottom, or base blank 503 and second or top or crown blank 504 for forming a container 505 (FIG. 11) of a third exemplary embodiment of the disclosure. The third exemplary embodiment is generally similar to the prior embodiments, except for variations noted and variations that will be apparent to one of ordinary skill in the art. Accordingly, similar or identical features of the embodiments have been given like or similar reference numbers. For example, the container 505 can be a four-sided (e.g., rectangular) container (e.g., wherein the corner panels and flaps are omitted from the blanks 503, 504 and the container 505). As shown in FIG. 9, the side panels 143, 145, 151, 153 are foldably connected to the bottom panel 511 along respective longitudinal fold lines 147, 149, 155, 157, and the end panels 127, 135 are foldably connected to the bottom panel along respective lateral fold lines 131, 139. In the illustrated embodiments, the side flange portions 577a, 577b can include end tabs for overlapping the respective end flange portions 175a, 175b at the corners of the container 505 (FIGS. 11 and 12). The blanks 503, 504 and/or the container 505 could be otherwise shaped, arranged, positioned, and/or configured without departing from the disclosure.

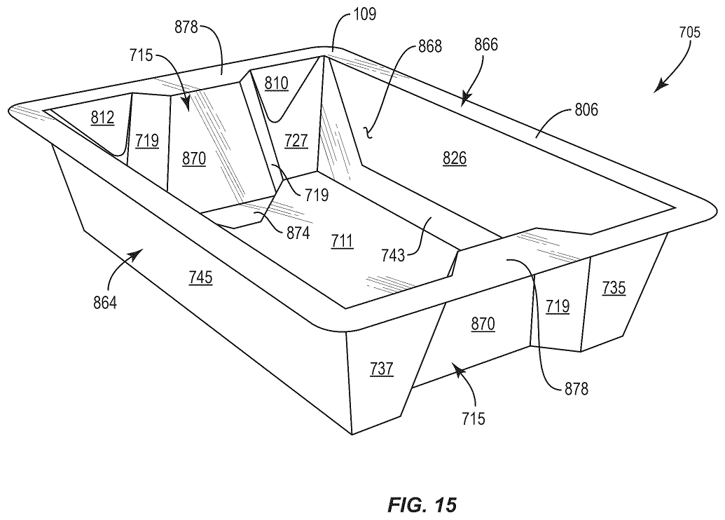

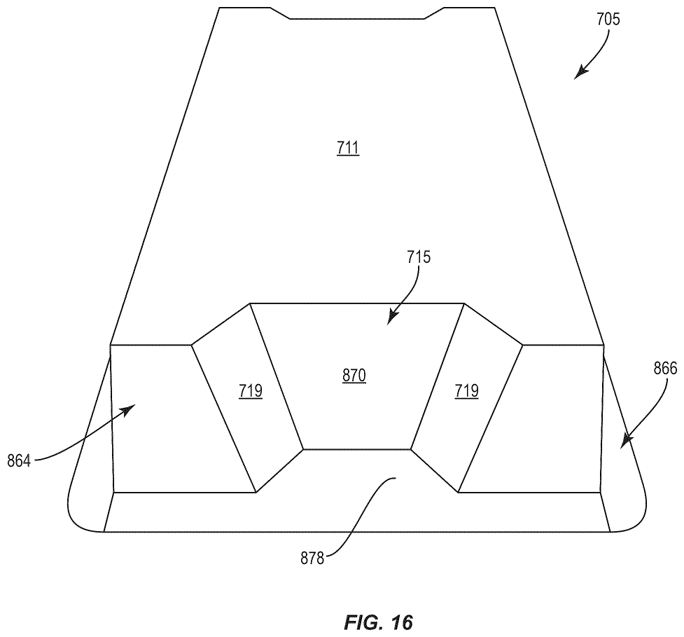

With additional reference to FIGS. 11 and 12, in the illustrated embodiments, the container 505 can be formed in a similar manner as the containers 105, 305 described above, wherein the container 505 has a base construct 680 and a crown 682. As shown in FIGS. 15 and 16, the sidewall 664 and the bottom panel 511 can extend along the interior 668 of the container 505, and the divider structures 515 can extend inwardly into the interior 668 from the sidewall 664 to at least partially form two interior portions of the container 505. In the illustrated embodiments, each of the divider structures 515 can be triangular and/or wedge shaped. In embodiments, the flange panel 606 of the crown 682 can cooperate with the flange portions 175a, 175b, 577a, 577b to form the flange 666 of the container 505.

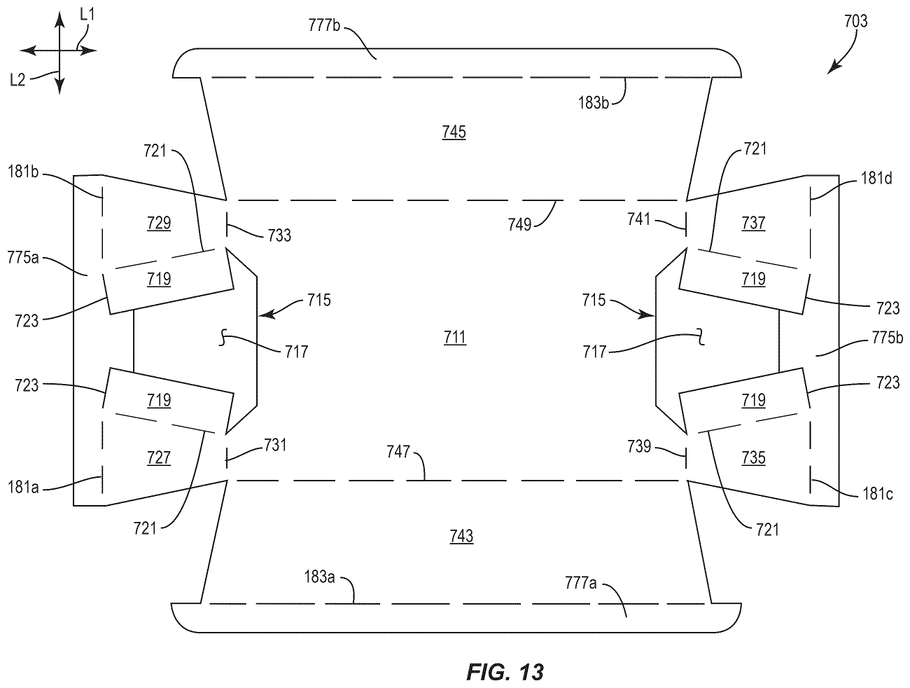

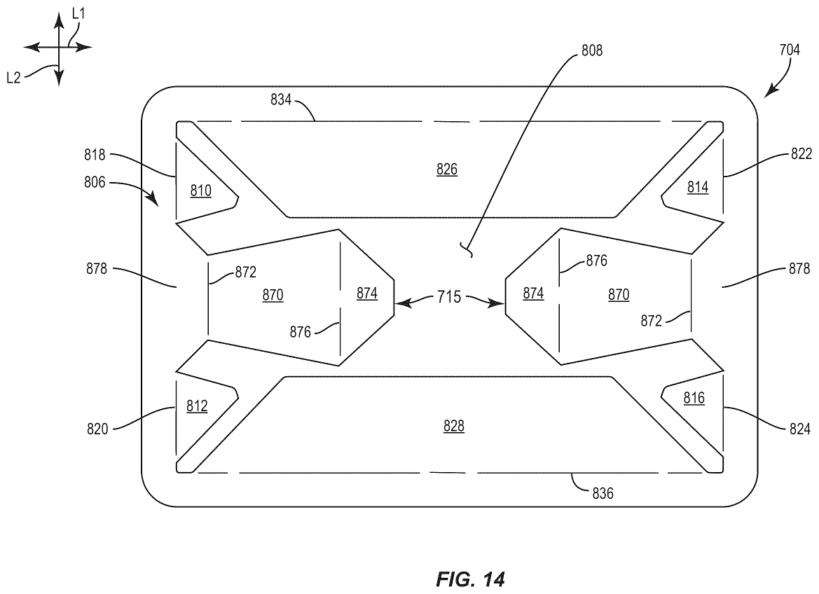

FIGS. 13 and 14 are plan views of a respective first, bottom, or base blank 703 and second or top or crown blank 704 for forming a container 705 (FIGS. 15-16) of a fourth exemplary embodiment of the disclosure. The fourth exemplary embodiment is generally similar to the prior embodiments, except for variations noted and variations that will be apparent to one of ordinary skill in the art. Accordingly, similar or identical features of the embodiments have been given like or similar reference numbers. For example, the container 705 can include divider structures 715 in the ends of the container 705 and formed from portions of the base 880 and the crown 882.

As shown in FIG. 13, the base blank 703 can include a bottom panel 711, a first end panel 727 and a second end panel 729 foldably connected to the bottom panel 711 along respective lateral fold lines 731, 733, opposing third end panel 735 and fourth end panel 737 foldably connected to the bottom panel 711 along respective lateral fold lines 739, 741. A first side panel 743 and an opposing second side panel 745 can be foldably connected to the bottom panel 711 along respective longitudinal fold lines 747, 749.

As shown in FIG. 13, the portions of the divider structures 715 in the bottom blank 703 can include cutouts 717 extending between the respective end panels 727, 729, along the respective flange portions 775a, 775b, and the bottom panel 711. Further, the divider structures 715 can include base divider flaps 719 foldably connected to the respective end panels 727, 729, 735, 737 along respective lateral fold lines 721 and extending along the respective cutouts 717. In exemplary embodiments, the base divider flaps 719 can be separable from the respective flange portions 775a, 775b along respective cut lines 723 or other suitable lines of weakening. The cutouts 717 and/or the base divider panels 719 could have any suitable shape and/or position without departing from the disclosure.

As shown in FIG. 14, the crown blank 704 can include a flange panel 806 extending around a perimeter of the top blank 704, a central opening 808, and a first end flap 810, a second end flap 812, a third end flap 814, and a fourth end flap 816 foldably connected to the flange panel 806 along the central opening 808 along respective lateral fold lines 818, 820, 822, 824. In embodiments, the blank 704 can include a first side flap 826 and a second side flap 828 foldably connected to the flange panel 806 along respective longitudinal fold lines 834, 836. As shown in FIG. 19, portions of the divider structures 715 in the top blank 704 can include top divider panels 870 foldably connected to the flange panel 806 along respective lateral fold lines 872 and top divider flaps 874 foldably connected to the respective top divider panels 870 along respective lateral fold lines 876. In the illustrated embodiments, each of the top divider panels 870 can be foldably connected to an extension 878 of the flange panel 806.

With additional reference to FIGS. 15 and 16, the container 705 can be formed in a similar manner as the containers 105, 305, 505, wherein the container 705 has a base construct 880, and a crown 882. The crown 882 and the base 880 can cooperate to form the container 705 with the flange panel 806 of the crown 882 overlapping the flange portions 775a, 775b, 777a, 777b of the base 880 to at least partially form the flange 866 of the container 705 and with the flaps 810, 812, 814, 816, 826, 828 of the crown 882 overlapping the respective panels 727, 729, 735, 737, 743, 745 of the base 880 to at least partially form the sidewall 864 of the container 705.

In the illustrated embodiments, the divider structures 715 can be formed by folding the base divider flaps 719 inwardly with respect to the respective end panels 727, 729, 735, 737 and folding the top divider panels 870 downwardly with respect to the extensions 878 of the flange panel 806. In embodiments, the top divider panels 870 can be positioned so that their edges abut the distal edges of the base divider flaps 719. As shown in FIGS. 21A-24, the top divider flaps 874 can be folded inwardly with respect to the respective top divider panels 870 and can be positioned to at least partially overlap the bottom panel 711 along the interior 868 of the container 705. In exemplary embodiments, the liner 109 can be attached along at least a portion of each of the flaps 810, 812, 814, 816, 826, 828, the panels 727, 729, 735, 737, 743, 745, the base divider flaps 719, the top divider panels 870, the top divider flaps 874, and the bottom panel 711 along the interior 868 of the container 705 to help hold the sidewall 864, including the divider structures 715, in shape. The sidewall 864 and the bottom panel 711 can extend along the interior 868 of the container 705, and the divider structures 715 can extend inwardly into the interior 868 from the sidewall 864 to at least partially form two interior portions of the container 705. In some embodiments, the divider structures 715 can be at least partially wedge-shaped.

The blanks 703, 704 and/or the container 705 could be otherwise shaped, arranged, positioned, and/or configured without departing from the disclosure.

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In general, the blanks may be constructed from paperboard having a caliper so that it is heavier and more rigid than ordinary paper. The blank can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A container for holding one or more articles, the container comprising:
an upper crown, the upper crown comprising a flange panel extending at least partially around an opening and a plurality of flaps foldably connected to the flange panel, the flange panel at least partially forming a flange of the container;
a base construct, the base construct comprising a bottom panel and a plurality of panels foldably connected to the bottom panel, the plurality of flaps of the upper crown and the plurality of bottom panels of the base construct forming a sidewall extending at least partially around an interior of the container; and
divider structures comprising a plurality of divider panels foldably connected to a respective panel of the plurality of panels of the base construct and forming the divider structures, the divider structures at least partially forming respective portions of the sidewall extending into the interior of the container.

2. The container of claim 1, wherein the divider structures further comprising a plurality of divider panels foldably connected to the flange panel for at least partially forming the divider structures.

3. The container of claim 1, wherein the plurality of flaps are in at least partial face-to-face contact with a respective panel of the plurality of panels of the base construct.

4. The container of claim 1, further comprising a liner at least partially overlying the upper crown and the base construct to secure the upper crown to the base construct.

5. The container of claim 1, wherein the plurality of panels of the base construct comprise a plurality of side panels and a plurality of end panels, and the plurality of divider panels are foldably connected to the plurality of side panels.

6. The container of claim 1, wherein the plurality of panels of the base construct comprise a plurality of side panels and a plurality of end panels, and the plurality of divider panels are foldably connected to the plurality of end panels.

7. The container of claim 1, wherein the divider structures have a wedge-shaped configuration.

8. A combination of blanks for a container for holding one or more articles, the container comprising:
a crown blank for forming an upper crown, the crown blank comprising a flange panel extending at least partially around an opening and a plurality of flaps foldably connected to the flange panel, the flange panel for at least partially forming a flange of the container;
a base blank for forming a base construct, the base blank comprising a bottom panel and a plurality of panels foldably connected to the bottom panel, the plurality of flaps of the crown blank and the plurality of panels of the base blank for forming a sidewall extending at least partially around an interior of the container formed from the combination of blanks; and
a plurality of divider panels foldably connected to a respective panel of the plurality of panels of the base construct for forming divider structures, the divider structures at least partially forming respective portions of the sidewall extending into the interior of the container formed from the combination of blanks.

9. The combination of blanks of claim 8, further comprising a plurality of divider panels foldably connected to the flange panel for at least partially forming the divider structures of the container formed from the combination of blanks.

10. The combination of blanks of claim 8, wherein the plurality of flaps are for being positioned in at least partial face-to-face contact with a respective panel of the plurality of panels of the base blank when the container is formed from the combination of blanks.

11. The combination of blanks of claim 8, further comprising a liner for at least partially overlying the upper blank and the base blank to secure the upper crown to the base construct when the container is formed from the combination of blanks.

12. The combination of blanks of claim 8, wherein the plurality of panels of the base blank comprise a plurality of side panels and a plurality of end panels, and the plurality of divider panels are foldably connected to the plurality of side panels.

13. The combination of blanks of claim 8, wherein the plurality of panels of the base construct comprise a plurality of side panels and a plurality of end panels, and the plurality of divider panels are foldably connected to the plurality of end panels.

14. A method of forming a container for holding one or more articles, the method comprising:
obtaining a crown blank, the crown blank comprising a flange panel extending at least partially around an opening and a plurality of flaps foldably connected to the flange panel;
obtaining a base blank, the base blank comprising a bottom panel and a plurality of panels foldably connected to the bottom panel, the base blank further comprising a plurality of divider panels foldably connected to a respective panel of the plurality of panels of the base construct;
forming an upper crown from the crown blank;
forming a base construct from the base blank;
at least partially forming a flange from the flange panel;
forming a sidewall from the plurality of flaps of the crown blank and the plurality of panels of the base blank such that the sidewall extends at least partially around an interior of the container; and
forming divider structures from the plurality of divider panels such that the divider structures at least partially form respective portions of the sidewall extending into the interior of the container.

15. The method of claim 14, further comprising a plurality of divider panels foldably connected to the flange panel for at least partially forming the divider structures.

16. The method of claim 14, wherein the plurality of flaps are in at least partial face-to-face contact method a respective panel of the plurality of panels of the base construct.

17. The method of claim 14, further comprising a liner, and the method further comprises at least partially overlying the upper crown and the base construct to secure the upper crown to the base construct.

18. The method of claim 14, wherein the plurality of panels of the base blank comprises a plurality of side panels and a plurality of end panels, and the plurality of divider panels are foldably connected to the plurality of side panels.

19. The method of claim 14, wherein the plurality of panels of the base construct comprise a plurality of side panels and a plurality of end panels, and the plurality of divider panels are foldably connected to the plurality of end panels.

20. The method of claim 14, wherein the divider structures have a wedge-shaped configuration.
